(19) United States
(12) Patent Application Publication
(10) Pub. No.: US 2020/0262977 A1
(43) Pub. Date: Aug. 20, 2020

(54) MELT POLYMERIZATION METHOD FOR POLYETHERIMIDES

(71) Applicant: SABIC GLOBAL TECHNOLOGIES B.V., Bergen op Zoom (NL)

(72) Inventors: Nitin Vilas Tople, Evansville, IN (US); Bernabe Quevedo Sanchez, Cartagena (ES); Juan Justino Rodriguez Ordonez, San Javier (ES); Javier Nieves Remacha, Madrid (ES)

(21) Appl. No.: 16/647,924

(22) PCT Filed: Sep. 19, 2018
(86) PCT No.: PCT/US2018/051695

§ 371 Date: Mar. 17, 2020

(30) Foreign Application Priority Data
Sep. 20, 2017 (EP) 17382617.3

(51) Int. Cl. C08G 73/10

(52) U.S. Cl. CPC C08G 73/1032; C08G 73/1053

(57) ABSTRACT

A method of making a polyetherimide includes forming a monomer mixture comprising a bis(ether anhydride), a diamine and a volatile organic solvent; removing the volatile organic solvent to form a particulate solid; and melt polymerizing the particulate solid at a temperature 50 to 225° C. greater than the glass transition temperature of the polyetherimide in a single melt mixing device. The polyetherimide has an anhydride-amine stoichiometry and the standard deviation of anhydride-amine stoichiometry is less than 0.4 mol %.

### BACKGROUND

Polyetherimides can be made by solution polymerization methods or by melt polymerization methods. Melt polymerization methods offer advantages but these advantages have been outweighed by difficulties associated with both the method and the polymer produced by the method. Further improvements to melt polymerization methods are needed.

### BRIEF DESCRIPTION

Disclosed herein is a method of making a polyetherimide comprising forming a monomer mixture comprising a bis(ether anhydride), a diamine and a volatile organic solvent; removing the volatile organic solvent to form a particulate solid; and melt polymerizing the particulate solid at a temperature 50 to 225° C. greater than the glass transition temperature of the polyetherimide in a single melt mixing device. The polyetherimide has an anhydride-amine stoichiometry and the standard deviation of anhydride-amine stoichiometry is less than 0.4 mol %. The polyetherimide also has a solvent content less than 50 ppm. The polyetherimide may have a chlorine content less than or equal to 50 ppm.

Also disclosed herein is a method of making a polyetherimide comprising forming a monomer mixture comprising 2,2-bis[4-(3,4-dicarboxyphenoxy)phenyl]propane dianhydride, a volatile organic solvent; and a diamine comprising m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing; removing the volatile organic solvent to form a particulate solid; and melt polymerizing the particulate solid at a temperature 50 to 225° C. greater than the glass transition temperature of the polyetherimide in a single melt mixing device. The polyetherimide has an anhydride-amine stoichiometry and the standard deviation of anhydride-amine stoichiometry is less than 0.4 mol %. The polyetherimide also has a solvent content less than 50 ppm. The polyetherimide may have a chlorine content less than or equal to 50 ppm.

Additionally disclosed is a melt polymerized polyetherimide having anhydride-amine stoichiometry wherein the standard deviation of anhydride-amine stoichiometry is less than 0.4 mol %. The polyetherimide also has a solvent content less than 50 ppm. The polyetherimide may have a chlorine content less than or equal to 50 ppm.

The above described and other features are exemplified by the following figures and detailed description.

### BRIEF DESCRIPTION OF THE DRAWINGS

The following figures are exemplary embodiments wherein the like elements are numbered alike.

FIGS. 1-6 show reaction conditions and data from the Examples.

### DETAILED DESCRIPTION

Melt polymerization methods may experience a “cement stage” in early stages of polymerization. The “cement stage” is characterized by extremely hard polymer of very high molecular weight. The presence of the “cement stage” can lead to non-steady operations and equipment failure.

It was discovered that the “cement stage” could be avoided by forming a mixture of the aromatic bis(ether anhydride), diamine and optional chain stopper using a volatile organic solvent. The solvent is then removed from the mixture to form a particulate solid. The particulate solid comprises a plurality of particles. The particulate solid is then melt polymerized. Without being bound by theory it is believed that by melt polymerizing the particulate solid the “cement stage” is avoided. As demonstrated in the Examples the “cement stage” appears to be the result of a non-homogenous distribution of monomers during melt polymerization.

In some embodiments the aromatic bis(ether anhydride) is combined with a volatile organic solvent to form a first mixture. The diamine is combined with a volatile organic solvent to form a second solution. A chain stopper, if used, may be with a volatile organic solvent to form a third mixture or combined with the aromatic bis(ether anhydride), with the diamine, with both. The volatile organic solvent used in the first, second and optional third mixture may be the same or different. For example, the first and third mixture may employ one volatile organic solvent while the second mixture employs a different volatile organic solvent. Any of the above mixtures with a volatile organic solvent may be a slurry or a solution.

Volatile organic solvents include those having a boiling point less than or equal to 65° C. at atmospheric pressure. Exemplary volatile organic solvents include dichloromethane, and chloroform and combinations of the foregoing.

As used herein the term “mixture” refers to a liquid mixture in which the minor component by weight (the bis(ether anhydride), diamine and/or the chain stopper) is uniformly distributed within the major component by weight (the solvent).

The first mixture, second mixture and, if used, the third mixture are combined to form the final mixture. In some embodiments the combination of the first, second and optional third mixtures may result in an exothermic reaction. The volatile organic solvent(s) is then removed from the final mixture to form a particulate solid. The particulate solid may have a solvent content of less than or equal to 1000 ppm, or less than or equal to 100 ppm. The solvent content of the solid may be determined by HPLC analysis.

The particulate solid is melt polymerized at a temperature 50 to 225° C., or 50 to 150° C. greater than the glass transition temperature of the polyetherimide in a single melt mixing device. In some embodiments melt polymerization occurs at a temperature of 300 to 450° C. Melt polymerization occurs in a single melt mixing device.

In some embodiments at least a portion of the melt polymerization is conducted at a pressure below atmospheric pressure (760 mm Hg or 101,325 Pa). In particular, the pressure may be less than or equal to 50,000 Pa, less than or equal to 25,000 Pa, less than or equal to 10,000 Pa, less than or equal to 5,000 Pa, or less than or equal to 1,000 Pa. In some embodiments the pressure is reduced for the final 50%, 35%, 25%, or 10% of the polymerization time. In some embodiments the pressure is reduced for the entire polymerization. In some embodiments the pressure is reduced once the reaction mixture has a weight average molecular weight that is greater than or equal to 20%, or greater than or equal to 60%, or greater than or equal to 90% of the weight average molecular weight of the polyetherimide.

The melt polymerization can be performed in an extruder, agitated thin film evaporator, large volume processor, mechanically agitated reactor or other melt mixing device. The aromatic bis(ether anhydride) and the diamine are present in amounts sufficient to obtain an anhydride-amine ratio of 0.99 to 1.025. The polymerization occurs for the time necessary to achieve the desired molecular weight and desired melt stability. The melt mixing device is vented to allow for removal of the water of reaction.

Polyetherimides comprise more than 1, for example 2 to 1000, or 5 to 500, or 10 to 100 structural units of formula (1)

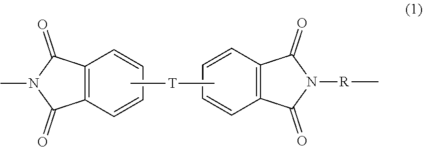

wherein each R is independently the same or different, and is a substituted or unsubstituted divalent organic group, such as a substituted or unsubstituted C₆₋₂₀ aromatic hydrocarbon group, a substituted or unsubstituted straight or branched chain C₄₋₂₀ alkylene group, a substituted or unsubstituted C₃₋₈ cycloalkylene group, in particular a halogenated derivative of any of the foregoing. In some embodiments R is divalent group of one or more of the following formulas (2)

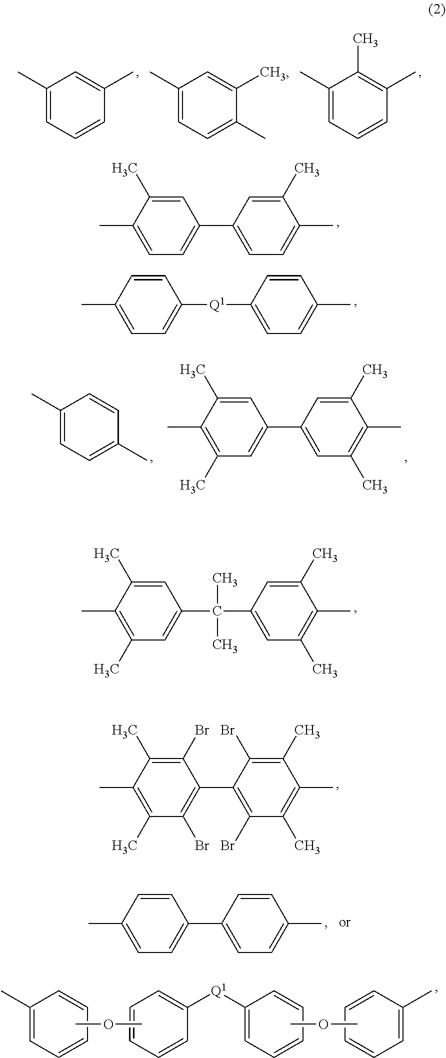

wherein Q¹ is —O—, —S—, —C(O)—, —SO₂—, —SO—, —P(R^{a})(═O)— wherein R^{a} is a C₁₋₈ alkyl or C₆₋₁₂ aryl, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, at least 10 mole percent or at least 50 mole percent of the R groups contain sulfone groups, and in other embodiments no R groups contain sulfone groups.

Further in formula (1), T is —O— or a group of the formula —O—Z—O— wherein the divalent bonds of the —O— or the —O—Z—O— group are in the 3,3′, 3,4′, 4,3′, or the 4,4′ positions, and Z is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z is not exceeded. Exemplary groups Z include groups of formula (3)

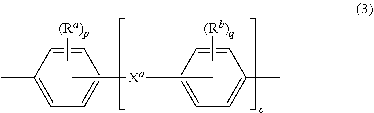

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

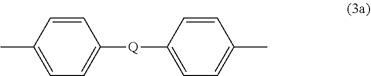

wherein Q is —O—, —S—, —C(O)—, —SO₂—, —SO—, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (including a perfluoroalkylene group). In a specific embodiment Z is a derived from bisphenol A, such that Q in formula (3a) is 2,2-isopropylidene.

In an embodiment in formula (1), R is m-phenylene, p-phenylene, or a combination comprising at least one of the foregoing, and T is —O—Z—O— wherein Z is a divalent group of formula (3a). Alternatively, R is m-phenylene, p-phenylene, or a combination comprising at least one of the foregoing, and T is —O—Z—O wherein Z is a divalent group of formula (3a) and Q is 2,2-isopropylidene. Alternatively, the polyetherimide can be a copolymer comprising additional structural polyetherimide units of formula (1) wherein at least 50 mole percent (mol %) of the R groups are bis(4,4′-phenylene)sulfone, bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z is 2,2-(4-phenylene)isopropylidene, i.e., a bisphenol A moiety.

In some embodiments, the polyetherimide is a copolymer that optionally comprises additional structural imide units that are not polyetherimide units, for example imide units of formula (4)

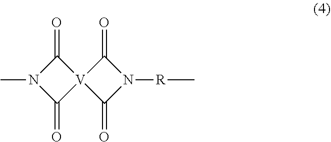

wherein R is as described in formula (1) and each V is the same or different, and is a substituted or unsubstituted C₆₋₂₀ aromatic hydrocarbon group, for example a tetravalent linker of the formulas

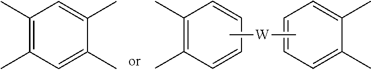

wherein W is a single bond, —O—, —S—, —C(O)—, —SO₂—, —SO—, a C₁₋₁₈ hydrocarbylene group, —P(R^{a})(═O)— wherein R^{a} is a C₁₋₈ alkyl or C₆₋₁₂ aryl, or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In some embodiments, no additional imide units are present in the polyetherimide.

The polyetherimide is prepared by melt polymerization of an aromatic bis(ether anhydride) of formula (5), with a diamine of formula (6)

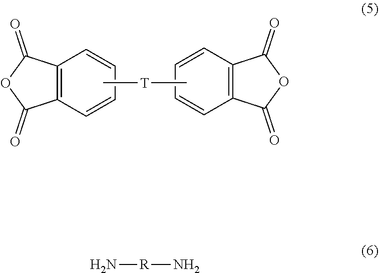

wherein T and R are defined as described above. Copolymers of the polyetherimides can be manufactured using a combination of an aromatic bis(ether anhydride) of formula (5) and an additional bis(anhydride) that is not a bis(ether anhydride), for example pyromellitic dianhydride or bis(3,4-dicarboxyphenyl) sulfone dianhydride.

Illustrative examples of aromatic bis(ether anhydride)s include 2,2-bis[4-(3,4-dicarboxyphenoxy)phenyl]propane dianhydride (also known as bisphenol A dianhydride or BPADA), 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; 4,4′-(hexafluoroisopropylidene)diphthalic anhydride; and 4-(2,3-dicarboxyphenoxy)-4′-(3,4-dicarboxyphenoxy)diphenyl sulfone dianhydride. A combination of different aromatic bis(ether anhydride)s can be used.

Examples of diamines include 1,4-butane diamine, 1,5-pentanediamine, 1,6-hexanediamine, 1,7-heptanediamine, 1,8-octanediamine, 1,9-nonanediamine, 1,10-decanediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2, 2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine (mPD), p-phenylenediamine (pPD), 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1, 3-diamino-4-isopropylbenzene, bis(4-aminophenyl) sulfide, bis-(4-aminophenyl) sulfone (also known as 4,4′-diaminodiphenyl sulfone (DDS)), and bis(4-aminophenyl) ether. Any regioisomer of the foregoing compounds can be used. C₁₋₄ alkylated or poly(C₁₋₄)alkylated derivatives of any of the foregoing can be used, for example a polymethylated 1,6-hexanediamine. Combinations of these compounds can also be used. In some embodiments the organic diamine is m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing.

In some embodiments the diamine is free of a stabilizer compound. Commercially available diamines can include stabilizer compounds such as a reducing agent used during production of the diamine. While intended to reduce degradation of the diamine the presence of these stabilizers in melt polymerization can negatively impact the melt stability of the resulting polyetherimide.

The polyetherimide may have terminal groups derived from a chain stopper. The chain stopper may be a monoamine or a monoanhydride. Exemplary chain stoppers include phthalic anhydride and aniline. The amount of chain stopper can be 2 to 8 mol % based on the total amount of the relevant functional group. For example, when the chain stopper is a monoanhydride, the mol % of chain stopper is defined as moles of monoanhydride/(moles of monoanhydride+2× moles of bis(ether anhydride)).

The polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide has a weight average molecular weight (Mw) of 1,000 to 150,000 grams/mole (Dalton), as measured by gel permeation chromatography (GPC), using polystyrene standards. In some embodiments the polyetherimide has an Mw of 10,000 to 80,000 Daltons. Such polyetherimides typically have an intrinsic viscosity greater than 0.2 deciliters per gram (dl/g), or, more specifically, 0.35 to 0.7 dl/g as measured in m-cresol at 25° C.

The polyetherimide can have a glass transition temperature of 180 to 310° C. as determined by differential scanning calorimetry (ASTM D3418).

The polyetherimide can have an anhydride-amine stoichiometry of 2.5 to −1 mol %, or 1 to −1 mol %. Anhydride-amine stoichiometry is defined as the mol % of anhydride—the mol % of amine groups. An anhydride-amine stoichiometry with a negative value indicates an excess of amine groups. Anhydride content and amine content can be determined by Fourier transformed infrared spectroscopy or near infrared spectroscopy.

The polyetherimide has a standard deviation of anhydride-amine stoichiometry of less than 0.4 mol %. The standard deviation of anhydride-amine stoichiometry is determined on the basis of 5 samples of the polyetherimide.

The polyetherimide may have a chlorine content less than or equal to 100 ppm, or less than or equal to 50 ppm, or, less than or equal to 25 ppm. Chlorine content can be determined using x-ray fluorescence spectrometry on a solid polyetherimide sample.

The polyetherimide has a solvent content less than 50 ppm, or less than 30 ppm, or less than 10 ppm. Solvent content may be determined by gas chromatography or liquid chromatography.

In some embodiments the polyetherimide has a change in melt viscosity of less than or equal to 50%, less than or equal to 40%, less than or equal to 30%, or less than or equal to 20% after being maintained for 30 minutes at 390° C. wherein melt viscosity is determined by ASTM D4440. In some embodiments, the polyetherimide has a change in melt viscosity of −30% to 50% after being maintained for 30 minutes at 390° C. wherein melt viscosity is determined by ASTM D4440.

This disclosure is further illustrated by the following examples, which are non-limiting.

### EXAMPLES

### Example 1

The mode of monomers addition, reaction conditions and agitator design were varied. Results showed that the pre-mixing method using an organic solvent produced polyetherimide with the lowest variability in its stoichiometry and therefore the most homogeneous properties.

Solvent-free polymerization reactions were carried-out in a glass reactor equipped with a mechanically agitator. The monomers were 2,2-bis[4-(3,4-dicarboxyphenoxy)phenyl]propane dianhydride (BPADA) and 1,3-phenylendiamine (mPD); and phthalic anhydride (PA) was added as chain stopper. Total reactants mass was 50 grams unless indicated otherwise, and all reactions in this example were formulated with a 0.5 molar percentage excess of anhydride and 2.7 mol % chain stopper.

In experiments using solid reactants the batch reactor tube was charged with solid reactants, the reactor was assembled, evacuated and refilled with nitrogen gas four times. The reaction mixture was electrically heated to a temperature of 250° C. and maintained this temperature for 10 minutes while the pressure was kept at 1013 mbar absolute. When the reactor content was fully melted, 5 minutes after reaching 250° C., the agitation was started up and raised to 20 rpm. Then, temperature was increased to 350° C. and maintained at this temperature for a total of 36 minutes to carry out the polymerization. The agitation was sequentially raised to reach a maximum of 80 rpm and the pressure was reduced to 1000 Pa to maintain these conditions for the last 22 minutes of reaction.

In experiments using pre-mixed monomer, 17.1 grams of mPD was added to 150 milliliters (mL) of dichloromethane and mixed in an ultrasonic bath until completely dissolved. 82.4 grams of BPADA were suspended in 1.3 liters (L) of dichloromethane and mixed for 10 minutes in an ultrasonic bath. 0.72 grams of PA were suspended in 50 milliliters (mL) of dichloromethane and mixed for 10 minutes in an ultrasonic bath. The three mixtures were combined together to have a total of 1.5 L. At this point, it was observed that an exothermic reaction occurred. The mixture was stirred in an ultrasonic bath for 2 hours at room temperature. The mixture was then removed from the ultrasonic bath and the solvent was evaporated in a rotovap at 50° C. and 75,000 Pa. The pressure was gradually reduced down to 30,000 Pa until no more condensate was observed. The rotovap operation lasted a total of 2.5 hours per batch. The solid was left to dry overnight in a vacuum oven at 30° C. and 10,000 Pa of pressure. After the procedure, a dry fine powder mix was obtained, ready to be charged into the glass reactor tube. The solid was added to the reactor tube and the melt polymerization was run as described in the preceding paragraph. Examples 1B and 1D used the same conditions and method.

Homogeneity of the polyetherimide was determined with the analysis of final stoichiometry by Fourier-transform Infrared Spectrometry (FTIR) in five different points of the final polymer mass. A negative stoichiometry indicates a polyetherimide which has an excess of amine end groups whereas a positive stoichiometry indicates a polyetherimide which has an excess of anhydride end groups. The pre-mixing of reactants using a volatile organic solvent resulted in a standard deviation below 0.1 mol %, as shown in Table 1. This is in comparison to the rest of the modifications which resulted in a standard deviation greater than or equal to 0.87 mol %.

TABLE 1

| | | | | | Standard |
|---|---|---|---|---|---|
| | | | | Average | deviation of |
| | Reactant | | Max agitator | stoichiometry of | stoichiometry |
| | mass (g) | Mode of addition | speed (rpm) | polymer (mol %) | (mol %) |
| A* | 50 | Solid monomers | 80 | −1.74 | 1.45 |
| B | 50 | Pre-mixing method | 80 | −1.01 | 0.05 |
| C* | 50 | Solid monomers | 10 | −0.55 | 2.08 |
| D | 50 | Pre-mixing method | 80 | −1.18 | 0.09 |
| E* | 30 | Solid monomers | 80 | −1.59 | 0.87 |

*Comparative

### Example 2

Three different reaction conditions were used to verify whether the “cement stage” transition occurred using the pre-mixing method and to characterize the properties of the polymer during this “cement stage”. This was achieved by stopping the reaction at intermediates states. It was concluded that the pre-mixing method eliminated the presence of the “cement stage” during the batch solvent-free polymerization of polyetherimide.

Procedure A (Comparative)

Solvent-free polymerization reactions were carried-out in a glass reactor equipped with a mechanical agitator. The monomers and chain stopper were charged as solids in the reactor tube and mixed with a metal rod prior to assembling the reactor. A total of 5 reactions were performed using this procedure with the objective of isolating the intermediate stages and study the time-evolution of the polymerization reaction. Therefore, the same procedure was followed for all experiments, but the reactions were stopped, cooled and analyzed at different reaction times.

A total reactants mass of 50 grams was charged in the reactor tube, and it was formulated at 0.5 molar percentage excess amine and 3.0% chain stopper. After the tube was charged with solid reactants and mixed with a metal rod, the reactor was assembled, evacuated and refilled with nitrogen gas four times. The reaction mixture was electrically heated to a temperature of 225° C. and maintained this temperature for 10 minutes while the pressure was kept at 101,300 Pa. When the reactor content was fully melted, 5 minutes after reaching 225° C., the agitation was started up and raised to 20 rpm. Then, temperature was increased to 350° C. and maintained at this temperature for a total of 30 minutes to carry out the polymerization at atmospheric pressure. The agitation was sequentially raised to reach 80 rpm three minutes after the reactor temperature reached 350° C. and maintained for 12 minutes. Then, agitation speed was raised to maintain a maximum of 100 rpm in the last 15 minutes of reaction. The reactions were stopped at intermediate stages, as indicated by the solid bars in FIG. 1.

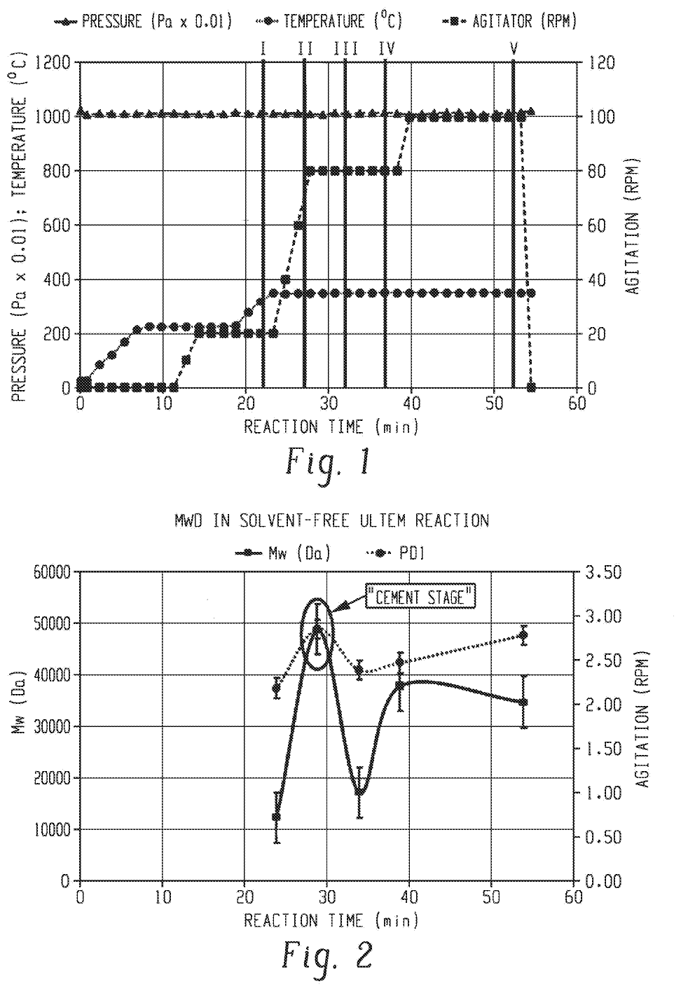

The “cement stage” was isolated in the reaction which was stopped 5 minutes after reaching 350° C. (reaction II). The molecular weight distribution was determined by GPC analysis for all the reactions and is shown in FIG. 2. It was observed that the “cement stage” had an abnormally high weight average molecular weight (Mw) and polydispersity (PDI) compared with the corresponding polymer mass in the early stages of the polymerization.

Procedure B (Comparative)

Solvent-free polymerization reactions were carried-out in a glass reactor equipped with a mechanically agitator. The monomers and chain stopper were charged as solids in the reactor tube and mixed with a metal rod prior to assembling the reactor. In this procedure, the BPADA was melted before the experiment to eliminate water and have better stoichiometry adjustment. A total of 5 reactions were performed with the objective of isolating the intermediate stages and study the time-evolution of the polymerization. Therefore, the same procedure was followed for all experiments, but the reactions were stopped, cooled and analyzed at different reaction times.

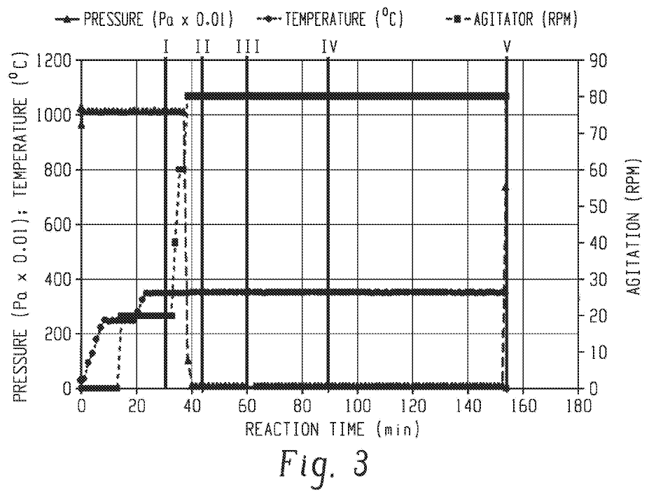

A total reactants mass of 50 grams was charged in the reactor tube, and it was formulated at 0.5 molar percentage excess anhydride and 2.7% chain stopper. After the tube was charged with solid reactants and mixed with a metal rod, the reactor was assembled, evacuated and refilled with nitrogen gas four times. The reaction mixture was electrically heated to a temperature of 250° C. and maintained this temperature for 10 minutes while the pressure was kept at 101,300 Pa. When the reactor content was fully melted, 5 minutes after reaching 250° C., the agitation was started up and raised to 20 rpm. Then, temperature was increased to 350° C. and maintained at this temperature for a total of 126 minutes to carry out the polymerization. The agitation was sequentially raised to reach a maximum of 80 rpm and the pressure was reduced to 1000 Pa to maintain these conditions for the last 112 minutes of reaction. The reactions were stopped at intermediate stages, as indicated by the solid bars in FIG. 3.

The “cement stage” was observed in reactions I and II stopped at 30 and 45 minutes of batch reaction time. The reaction mixture was not homogeneous, as verified with measurement of stoichiometry at different point of the reaction mass. The “cement stage” showed an excess of anhydride groups. Therefore, it was confirmed that the polymerization goes through a “cement stage” when solid monomers are charged directly to the reactor. There were two phases in the reaction mass, an amine rich phase at the bottom of the reactor and an anhydride rich phase at the top of the reactor tube, thus providing further evidence that monomers melting at different temperatures produce a heterogeneous reaction mixture.

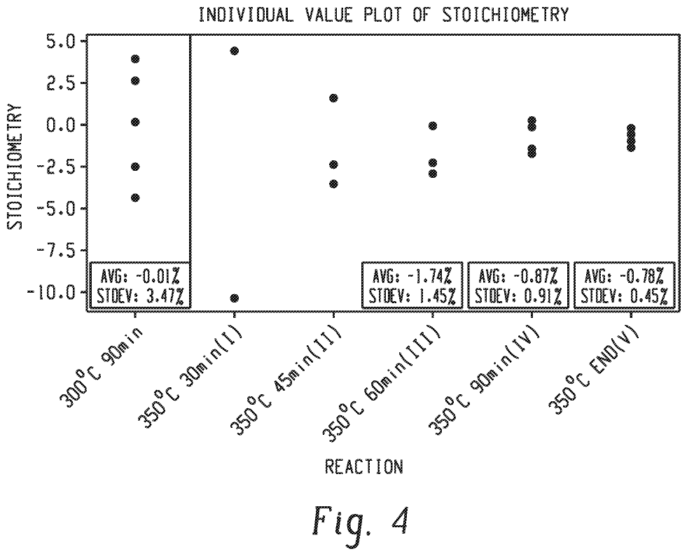

Individual measurements of stoichiometry are shown in FIG. 4 and compared with a reaction performed at 300° C. for a total time of 90 minutes. The variability of the reaction mixture was reduced with increasing temperature to 350° C. and extending reaction time. Stoichiometry measurement from 5 aliquots in reaction IV showed a standard deviation of 0.45 mol %. This is a large variability when compared to the standard deviations of less than 0.1 mol percent in reactions using the pre-mixing method.

Procedure C

The monomers and chain stoppers were pre-mixed in an organic solvent to produce a homogeneous powder mix, which was charged in the glass reactor tube to carry out the solvent-free polymerization reactions. A total of 4 reactions were performed with the objective of isolating the intermediate stages and study the time-evolution of the polymerization reaction. Therefore, the same procedure was followed for all experiments, but the reactions were stopped, cooled and analyzed at different reaction times

The mix of reactants was formulated at 1 molar percentage excess anhydride and 2.2% chain stopper. A weighted amount of 17.3 grams of mPD was added to 150 mL of dichloromethane and mixed in an ultrasonic bath until complete dissolution. A quantity of 84 grams of BPADA were suspended in 1.3 L of dichloromethane and mixed for 10 minutes in an ultrasonic bath. A quantity of 0.49 grams of PA were suspended in 50 mL of dichloromethane and mixed for 10 minutes in an ultrasonic bath. Then, the three solutions were mixed together to have a total of 1.5 L. At this point, it was observed that an exothermic reaction occurred. The mixture was stirred in an ultrasonic bath for 2 hours at room temperature. Later the solvent was evaporated in a rotovap at 50° C. and 75,000 Pa. The pressure was gradually reduced down to 3000 Pa until no more condensate was observed. The rotovap operation lasted a total of 2.5 hours per batch. Then, the solid was left to dry overnight in a vacuum oven at 30° C. and 10,000 Pa of pressure. After the pre-mixing method, a dry fine powder mix was obtained, ready to be charged into the glass reactor tube.

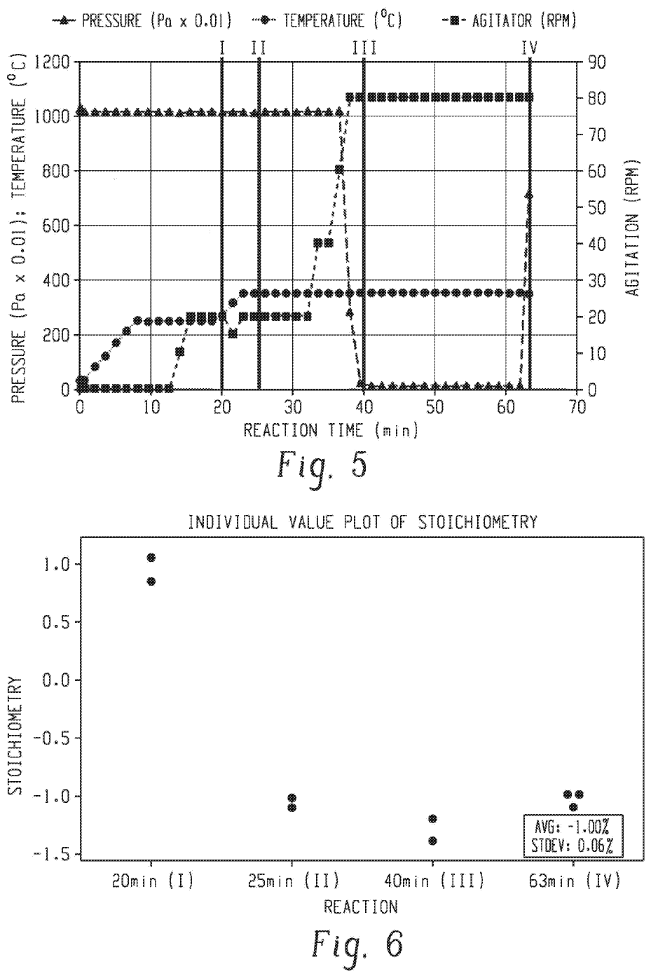

A total reactants mass of 45 grams was charged in the reactor tube. After the charge was completed, the reactor was assembled, evacuated and refilled with nitrogen gas four times. The reaction mixture was electrically heated to a temperature of 250° C. and maintained this temperature for 10 minutes while the pressure was kept at 1013 mbar absolute. When the reactor content was fully melted, 5 minutes after reaching 250° C., the agitation was started up and raised to 20 rpm. Then, temperature was increased to 350° C. and maintained at this temperature for a total of 36 minutes to carry out the polymerization. The agitation was sequentially raised to reach a maximum of 80 rpm and the pressure was reduced to 1,000 Pa to maintain these conditions for the last 22 minutes of reaction. Profiles of pressure, temperature and agitation speed during polymerization are shown in FIG. 5, as indicated by the solid bars.

No “cement stage” was observed in reactions stopped at 20 and 25 minutes of batch reaction time. The reaction mixtures were homogeneous, as verified with measurement of stoichiometry at different point of the reaction mass (see FIG. 6). Therefore, it was confirmed that the pre-mixing method favors the homogeneous melting of the reactants and eliminates the formation of the “cement stage”.

The standard deviation of stoichiometry is 0.06 mol % at the end of polymerization using the pre-mixing method (Procedure C). Comparison of this result to a standard deviation of 0.45 mol % adding solid monomers (see FIG. 4) confirms that the pre-mixing method produces a more homogeneous resin.

This disclosure further encompasses the following embodiments.

### Embodiment 1

A method of making a polyetherimide comprises forming a monomer mixture comprising a bis(ether anhydride), a diamine and a volatile organic solvent; removing the volatile organic solvent to form a particulate solid; and melt polymerizing the particulate solid at a temperature of 50 to 225° C. higher than the glass transition temperature of the polyetherimide in a single melt mixing device to produce a polyetherimide having an anhydride-amine stoichiometry and the standard deviation of anhydride-amine stoichiometry is less than 0.4 mol %.

### Embodiment 2

The method of Embodiment 1, wherein the monomer mixture is formed by combining a bis(ether anhydride) mixture and a diamine mixture, wherein the bis(ether anhydride) mixture comprises the bis(ether anhydride) and the volatile organic solvent and the diamine mixture comprises the diamine and the volatile organic solvent.

### Embodiment 3

The method of Embodiment 2, wherein the bis(ether anhydride) mixture further comprises a chain stopper.

### Embodiment 4

The method of Embodiment 2, wherein the diamine mixture further comprises a chain stopper.

### Embodiment 5

The method of any one of Embodiments 1 to 4, wherein at least a portion of the melt polymerization is conducted at a pressure below atmospheric pressure (760 mm Hg or 101,325 Pa).

### Embodiment 6

The method of any one of Embodiments 1 to 5, wherein an excess of bis(ether anhydride) relative to the diamine is used to produce a polyetherimide having an excess of anhydride groups relative to the amount of amine groups.

### Embodiment 7

The method of any one of Embodiments 1 to 6, wherein the volatile organic solvent comprises dichloromethane, acetone, or a combination of the foregoing.

### Embodiment 8

The method of any one of Embodiments 1 to 7, wherein melt polymerizing occurs at a temperature 50 to 150° C. greater than the glass transition temperature of the polyetherimide.

### Embodiment 9

The method of any one of Embodiment 1 to 8, wherein at least a portion of the melt polymerization is conducted at a pressure less than or equal to 5,000 Pa, or less than or equal to 1,000 Pa.

### Embodiment 10

The method of any one of claims 1 to 9, wherein the bis(ether anhydride) comprises 2,2-bis[4-(3,4-dicarboxyphenoxy)phenyl]propane dianhydride.

### Embodiment 11

The method of any one of Embodiments 1 to 10, wherein the diamine comprises m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing.

### Embodiment 12

The method of any one of the preceding Embodiments, wherein the particulate solid has a solvent content less than or equal to 1000 ppm, or less than or equal to 100 ppm.

### Embodiment 13

A melt polymerized polyetherimide having anhydride-amine stoichiometry wherein the standard deviation of anhydride-amine stoichiometry is less than 0.4 mol % and a solvent content less than 50 ppm.

### Embodiment 14

The polyetherimide of Embodiment 13, wherein the polyetherimide has an anhydride-amine stoichiometry of −1 to 2.5 mol %.

### Embodiment 15

The polyetherimide of Embodiment 13 or 14, wherein the polyetherimide has a chlorine content less than or equal to 50 ppm, or less than or equal to 25 ppm.

### Embodiment 16

The polyetherimide of any one of Embodiments 13 to 15, wherein the polyetherimide has a change in melt viscosity of less than or equal to 50%, less than or equal to 40%, less than or equal to 30%, or less than or equal to 20% after being maintained for 30 minutes at 390° C. wherein melt viscosity is determined by ASTM D4440.

### Embodiment 17

The polyetherimide of any one of Embodiments 13 to 16 comprising structural units derived from 2,2-bis[4-(3,4-dicarboxyphenoxy)phenyl]propane dianhydride and one or more diamines comprising m-phenylenediamine, p-phenylenediamine, 4,4′-diaminodiphenyl sulfone, 3,4′-diaminodiphenyl sulfone, or 3,3′-diaminodiphenyl sulfone.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl” includes groups containing carbon, hydrogen, and optionally one or more heteroatoms (e.g., 1, 2, 3, or 4 atoms such as halogen, O, N, S, P, or Si). “Alkyl” means a branched or straight chain, saturated, monovalent hydrocarbon group, e.g., methyl, ethyl, i-propyl, and n-butyl. “Alkylene” means a straight or branched chain, saturated, divalent hydrocarbon group (e.g., methylene (—CH₂—) or propylene (—(CH₂)₃—)). “Alkenyl” and “alkenylene” mean a monovalent or divalent, respectively, straight or branched chain hydrocarbon group having at least one carbon-carbon double bond (e.g., ethenyl (—HC═CH₂) or propenylene (—HC(CH₃)═CH₂—). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy, ethoxy, and sec-butyloxy. “Cycloalkyl” and “cycloalkylene” mean a monovalent and divalent cyclic hydrocarbon group, respectively, of the formula —CₙH₂ₙ₋ₓ and —CₙH₂ₙ₋₂ₓ— wherein x is the number of cyclization(s). “Aryl” means a monovalent, monocyclic or polycyclic aromatic group (e.g., phenyl or naphthyl). “Arylene” means a divalent, monocyclic or polycyclic aromatic group (e.g., phenylene or naphthylene). “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more halogen (F, Cl, Br, or I) substituents, which can be the same or different. The prefix “hetero” means a group or compound that includes at least one ring member that is a heteroatom (e.g., 1, 2, or 3 heteroatoms, wherein each heteroatom is independently N, O, S, or P.

“Substituted” means that the compound or group is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g, benzyl), C₇₋₁₂ alkylarylene (e.g, toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the group, including those of the substituent(s).

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method of making a polyetherimide comprises forming a monomer mixture comprising a bis(ether anhydride), a diamine and a volatile organic solvent; removing the volatile organic solvent to form a particulate solid; and melt polymerizing the particulate solid at a temperature of 50 to 225° C. higher than the glass transition temperature of the polyetherimide in a single melt mixing device to produce a polyetherimide having an anhydride-amine stoichiometry and the standard deviation of anhydride-amine stoichiometry is less than 0.4 mol %.

2. The method of claim 1, wherein the monomer mixture is formed by combining a bis(ether anhydride) mixture and a diamine mixture, wherein the bis(ether anhydride) mixture comprises the bis(ether anhydride) and the volatile organic solvent and the diamine mixture comprises the diamine and the volatile organic solvent.

3. The method of claim 2, wherein the bis(ether anhydride) mixture further comprises a chain stopper.

4. The method of claim 2, wherein the diamine mixture further comprises a chain stopper.

5. The method of claim 1, wherein at least a portion of the melt polymerization is conducted at a pressure below atmospheric pressure (760 mm Hg or 101,325 Pa).

6. The method of claim 1, wherein an excess of bis(ether anhydride) relative to the diamine is used to produce a polyetherimide having an excess of anhydride groups relative to the amount of amine groups.

7. The method of claim 1, wherein the volatile organic solvent comprises dichloromethane, chloroform, or a combination of the foregoing.

8. The method of claim 1, wherein melt polymerizing occurs at a temperature 50 to 150° C. greater than the glass transition temperature of the polyetherimide.

9. The method of claim 1, wherein at least a portion of the melt polymerization is conducted at a pressure less than or equal to 5,000 Pa.

10. The method of claim 1, wherein the bis(ether anhydride) comprises 2,2-bis[4-(3,4-dicarboxyphenoxy)phenyl]propane dianhydride.

11. The method of claim 1, wherein the diamine comprises m-phenylenediamine, p-phenylenediamine, 4,4′-diaminodiphenyl sulfone, 3,4′-diaminodiphenyl sulfone, 3,3′-diaminodiphenyl sulfone, or a combination comprising at least one of the foregoing.

12. The method of claim 1, wherein the particulate solid has a solvent content less than or equal to 1000 ppm.

13. A melt polymerized polyetherimide having anhydride-amine stoichiometry wherein the standard deviation of anhydride-amine stoichiometry is less than 0.4 mol % and a solvent content less than 50 ppm.

14. The polyetherimide of claim 13, wherein the polyetherimide has an anhydride-amine stoichiometry of −1 to 2.5 mol %.

15. The polyetherimide of claim 13, wherein the polyetherimide has a chlorine content less than or equal to 50 ppm.

16. The polyetherimide of claim 13, wherein the polyetherimide has a change in melt viscosity of less than or equal to 50% after being maintained for 30 minutes at 390° C. wherein melt viscosity is determined by ASTM D4440.

17. The polyetherimide of claim 13 comprising structural units derived from 2,2-bis[4-(3,4-dicarboxyphenoxy)phenyl]propane dianhydride and one or more diamines comprising m-phenylenediamine, p-phenylenediamine, 4,4′-diaminodiphenyl sulfone, 3,4′-diaminodiphenyl sulfone, or 3,3′-diaminodiphenyl sulfone.
